(19) United States
(12) Patent Application Publication
(10) Pub. No.: US 2025/0349453 A1
(43) Pub. Date: Nov. 13, 2025

(54) INDUCTOR COMPONENT

(71) Applicant: Murata Manufacturing Co., Ltd., Kyoto-fu (JP)

(72) Inventors: Kenji TOYOSHIMA, Nagaokakyo-shi (JP); Taiga KATO, Nagaokakyo-shi (JP); Eiji YAMAUCHI, Nagaokakyo-shi (JP); Yoshimasa YOSHIOKA, Nagaokakyo-shi (JP)

(73) Assignee: Murata Manufacturing Co., Ltd., Kyoto-fu (JP)

(21) Appl. No.: 19/191,686

(22) Filed: Apr. 28, 2025

(30) Foreign Application Priority Data
May 7, 2024 (JP) 2024-075352

(51) Int. Cl. H01F 17/00; H01F 27/29

(52) U.S. Cl. CPC H01F 17/0013; H01F 27/292; H01F 2017/002

(57) ABSTRACT

An inductor component includes a coil wiring line that is in a main body and that is wound around an axial direction; first and second external terminals on an outer surface of the main body; a first connection conductor that extends in the axial direction and that is connected to the first external terminal and the coil wiring line; and a second connection conductor connected to the second external terminal and the coil wiring line. The coil wiring line includes winding portions including a first winding portion wound around the axial direction from one end portion of the first winding portion connected to the first connection conductor to form 1 turn, and a second winding portion that is continuous with another end portion of the first winding portion and that extends around the axial direction.

### CROSS-REFERENCE TO RELATED APPLICATION

This application claims benefit of priority to Japanese Patent Application No. 2024-075352, filed May 7, 2024, the entire content of which is incorporated herein by reference.

### BACKGROUND

### Technical Field

The present disclosure relates to an inductor component in which a coil wiring line is provided in a main body.

### Background Art

Japanese Unexamined Patent Application Publication No. 2023-175582 discloses a coil component as an example of such an inductor component in which a coil wiring line is provided in a main body.

In the coil component disclosed in Japanese Unexamined Patent Application Publication No. 2023-175582, two end portions of a coil wiring line provided in a base body are connected, via via conductors, to respective outer electrodes provided on an outer surface of the base body.

### SUMMARY

In the coil component disclosed in Japanese Unexamined Patent Application Publication No. 2023-175582, an electric current may leak between the coil wiring line and the outer electrodes due to, for example, electrostatic discharge (ESD).

Accordingly, the present disclosure provides an inductor component capable of reducing electric current leakage.

An inductor component according to an aspect of the present disclosure includes a main body containing a magnetic material; a coil wiring line that is provided in the main body and that is wound around an axial direction to form a coil; a first external terminal provided on a crossing surface crossing the axial direction of outer surfaces of the main body; a second external terminal provided on an outer surface of the main body; a first connection conductor that is provided in the main body, that extends in the axial direction, and that is connected to the first external terminal and the coil wiring line; and a second connection conductor that is provided in the main body and that is connected to the second external terminal and the coil wiring line. The coil wiring line includes a plurality of winding portions extending in a circumferential direction around the axial direction. The plurality of winding portions at least include a first winding portion wound around the axial direction from one end portion of the first winding portion connected to the first connection conductor to form 1 turn, and a second winding portion that is continuous with another end portion of the first winding portion and that extends around the axial direction inside the first winding portion. The first winding portion includes a first portion extending from the one end portion of the first winding portion in a direction having a component of a specific direction that is a direction in which a tangent passing through the one end portion of the first winding portion extends of the circumferential direction. The second winding portion includes a second portion extending from the other end portion of the first winding portion in a direction having the component of the specific direction. When viewed in the axial direction, at least a part of the second portion in a width direction at any position in the second portion does not overlap the first external terminal.

According to the present disclosure, it is possible to provide an inductor component capable of reducing electric current leakage.

### BRIEF DESCRIPTION OF THE DRAWINGS

FIG. 1 is a schematic external perspective view of an inductor component according to Embodiment 1 of the present disclosure;

FIG. 2 is a schematic plan view of a coil wiring line of the inductor component according to Embodiment 1 of the present disclosure;

FIG. 3 is a schematic sectional view illustrating section III-III in FIG. 1;

FIG. 4 is a schematic sectional view illustrating a method for manufacturing the inductor component according to Embodiment 1 of the present disclosure;

FIG. 5 is a schematic sectional view illustrating a step subsequent to that in FIG. 4 of the method for manufacturing the inductor component according to Embodiment 1 of the present disclosure;

FIG. 6 is a schematic sectional view illustrating a step subsequent to that in FIG. 5 of the method for manufacturing the inductor component according to Embodiment 1 of the present disclosure;

FIG. 7 is a schematic sectional view illustrating a step subsequent to that in FIG. 6 of the method for manufacturing the inductor component according to Embodiment 1 of the present disclosure;

FIG. 8 is a schematic sectional view illustrating a step subsequent to that in FIG. 7 of the method for manufacturing the inductor component according to Embodiment 1 of the present disclosure;

FIG. 9 is a schematic sectional view illustrating a step subsequent to that in FIG. 8 of the method for manufacturing the inductor component according to Embodiment 1 of the present disclosure;

FIG. 10 is a schematic sectional view illustrating a step subsequent to that in FIG. 9 of the method for manufacturing the inductor component according to Embodiment 1 of the present disclosure;

FIG. 11 is a schematic sectional view illustrating a step subsequent to that in FIG. 10 of the method for manufacturing the inductor component according to Embodiment 1 of the present disclosure;

FIG. 12 is a schematic sectional view illustrating a step subsequent to that in FIG. 11 of the method for manufacturing the inductor component according to Embodiment 1 of the present disclosure;

FIG. 13 is a schematic sectional view illustrating a step subsequent to that in FIG. 12 of the method for manufacturing the inductor component according to Embodiment 1 of the present disclosure;

FIG. 14 is a schematic sectional view illustrating a step subsequent to that in FIG. 13 of the method for manufacturing the inductor component according to Embodiment 1 of the present disclosure;

FIG. 15 is a schematic plan view of a coil wiring line of an inductor component according to Embodiment 2 of the present disclosure; and

FIG. 16 is a schematic sectional view illustrating a section corresponding to section III-III in FIG. 1 of the inductor component according to Embodiment 2 of the present disclosure.

### DETAILED DESCRIPTION

Examples of the present disclosure will be described below with reference to the accompanying drawings. The following description is essentially merely an example and is not intended to limit the present disclosure and the application and use of the present disclosure. In addition, the drawings are schematic, and, for example, size ratios therein do not necessarily coincide with actual ones. In addition, in the following description, terms that mean specific directions or positions (for example, terms including “up”, “down”, “right”, “left”, “forward”, or “backward”) are used as appropriate. However, such terms that mean specific directions or positions are used to facilitate understanding of the present disclosure with reference to the drawings, and the meanings of these terms do not limit the technical scope of the present disclosure.

### Embodiment 1

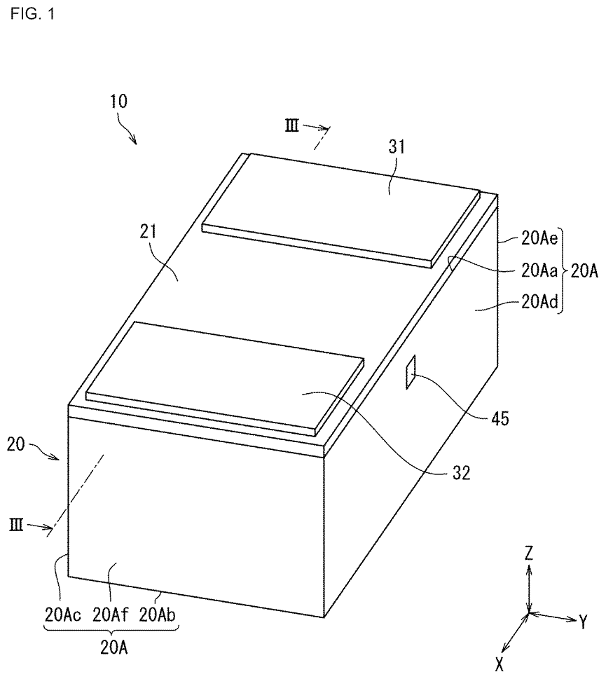

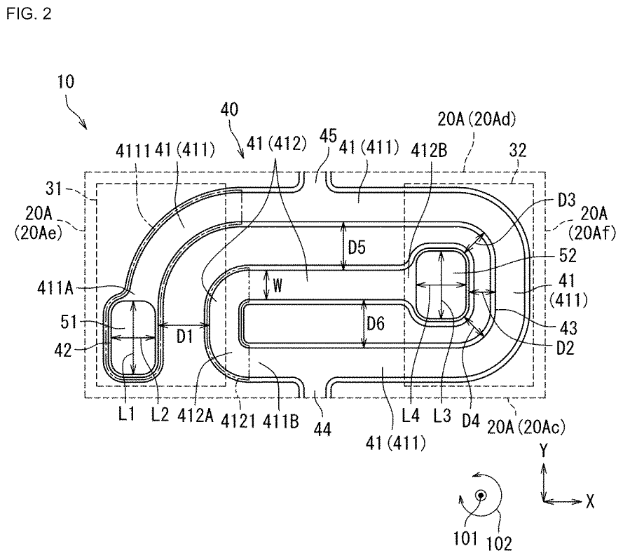

FIG. 1 is a schematic external perspective view of an inductor component according to Embodiment 1 of the present disclosure. FIG. 1 and the below-described FIGS. 2 to 16 are schematic drawings. Thus, for example, the respective sizes, shapes, and numbers of a main body 20, a coil wiring line 40, a first external terminal 31, a second external terminal 32, a first connection conductor 51, a second connection conductor 52, and other components illustrated in FIGS. 1 to 16 may differ from those of actual ones.

As illustrated in FIG. 1, an inductor component 10 according to the embodiment of the present disclosure includes the main body 20, an external insulating layer 21, the first external terminal 31, and the second external terminal 32.

The main body 20 has a cuboid shape. In the present embodiment, outer surfaces 20A of the main body 20 include an upper surface 20Aa, which faces upward, a lower surface 20Ab, which faces downward, a front side surface 20Ac, a rear side surface 20Ad, a left side surface 20Ae, and a right side surface 20Af, which connect the upper surface 20Aa and the lower surface 20Ab. The front side surface 20Ac faces forward. The rear side surface 20Ad faces backward. The left side surface 20Ae faces leftward. The right side surface 20Af faces rightward. That is, the upper surface 20Aa and the lower surface 20Ab face in opposite directions, the front side surface 20Ac and the rear side surface 20Ad face in opposite directions, and the left side surface 20Ae and the right side surface 20Af face in opposite directions. In the drawings, the X direction, the Y direction, and the Z direction are represented by arrows. In the present embodiment, the X direction is a left-right direction, the Y direction is a front-rear direction, and the Z direction is an up-down direction. The X direction, the Y direction, and the Z direction are orthogonal to each other. The shape of the main body 20 is not limited to a cuboid shape and may be a different shape such as a cylindrical shape.

The upper surface 20Aa and the lower surface 20Ab cross (in the present embodiment, are orthogonal to) the Z direction. The front side surface 20Ac, the rear side surface 20Ad, the left side surface 20Ae, and the right side surface 20Af are parallel to the Z direction.

The main body 20 contains a magnetic material. This will be described below in detail. The main body 20 contains a magnetic powder (magnetic material) and a resin containing the magnetic powder. For example, the resin is an epoxy resin, a phenolic resin, a liquid crystal polymer resin, a polyimide resin, an acrylic resin, or an organic insulating material made of a mixture of these substances. For example, the magnetic powder is made of a FeSi alloy such as a FeSiCr alloy, a FeCo alloy, a Fe alloy such as a NiFe alloy, or an amorphous alloy thereof. Thus, compared with a configuration in which the main body 20 is made of only ferrite, direct current superposed characteristics can be improved by the magnetic powder, and pieces of the magnetic powder are insulated from each other by the resin, resulting in a reduction in loss (iron loss) at a high frequency. The main body 20 may be made of, for example, ferrite or a sintered body of magnetic powder and may thus be made without an organic resin. That is, the entire main body 20 may be made of a magnetic material. Needless to say, as described above, a part of the main body 20 may be made of a magnetic material, and the other part of the main body 20 may be made of a material different from the magnetic material.

In the present embodiment, the median grain size D50 of the magnetic material contained in the main body 20 is equal to or less than 10 μm. The median grain size D50 of the magnetic material contained in the main body 20 may be more than 10 μm.

The external insulating layer 21 is laminated on the upper surface 20Aa of the main body 20. The external insulating layer 21 is an example of an insulating layer. The external insulating layer 21 is laminated on a partial region of the upper surface 20Aa. The first external terminal 31 and the second external terminal 32 are provided on respective parts of the upper surface 20Aa other than the partial region. The external insulating layer 21 is made of an insulator. For example, the external insulating layer 21 is made of acrylate and silicon dioxide (SiO₂).

The first external terminal 31 and the second external terminal 32 are provided on the upper surface 20Aa of the main body 20. The first external terminal 31 is provided on the left part of the upper surface 20Aa. The second external terminal 32 is provided on the right part of the upper surface 20Aa. The first external terminal 31 and the second external terminal 32 are made of conductive materials. In the present embodiment, the first external terminal 31 and the second external terminal 32 each have a three-layer structure in which Cu, which has a low electrical resistance and excellent stress resistance, Ni, which has excellent corrosion resistance, and Au, which has excellent wettability and excellent reliability, are arranged in this order from the inside to the outside.

The first external terminal 31 may be provided on a part of the upper surface 20Aa other than the left part. The second external terminal 32 may be provided on a part of the upper surface 20Aa other than the right part. The second external terminal 32 may be provided on a part of the main body 20 other than the upper surface 20Aa.

In the present embodiment, the first external terminal 31 and the second external terminal 32 are provided on the same surface (upper surface 20Aa) of the main body 20. However, the first external terminal 31 and the second external terminal 32 may be provided on different surfaces of the main body 20. For example, whereas the first external terminal 31 may be provided on the upper surface 20Aa, the second external terminal 32 may be provided on the right side surface 20Af.

In the present embodiment, each of the first external terminal 31 and the second external terminal 32 is provided on one surface (upper surface 20Aa) of the main body 20. However, each of the first external terminal 31 and the second external terminal 32 may be provided on and extend over a plurality of surfaces of the main body 20. For example, the first external terminal 31 may be provided on and extend over the entire left side surface 20Ae and the left part of each of the upper surface 20Aa, the lower surface 20Ab, the front side surface 20Ac, and the rear side surface 20Ad. In addition, for example, the second external terminal 32 may be provided on and extend over the entire right side surface 20Af and the right part of each of the upper surface 20Aa, the lower surface 20Ab, the front side surface 20Ac, and the rear side surface 20Ad.

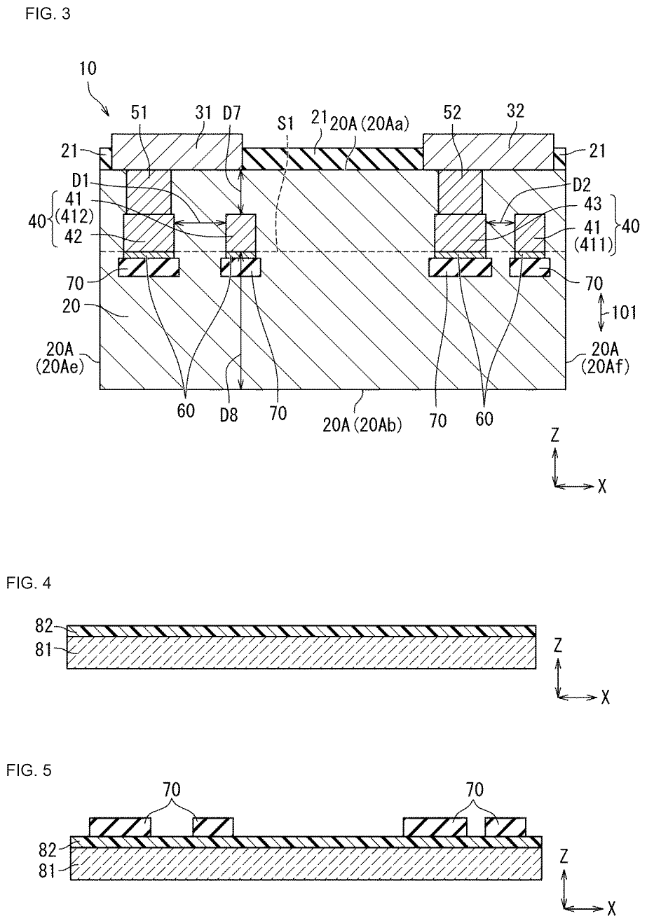

FIG. 2 is a schematic plan view of a coil wiring line of the inductor component according to Embodiment 1 of the present disclosure. FIG. 3 is a schematic sectional view illustrating section III-III in FIG. 1.

As illustrated in FIGS. 2 and 3, the inductor component 10 includes the coil wiring line 40, the first connection conductor 51, the second connection conductor 52, a seed layer 60, and an internal insulating layer 70.

The coil wiring line 40, the first connection conductor 51, the second connection conductor 52, the seed layer 60, and the internal insulating layer 70 are provided in the main body 20 and are interposed between the upper surface 20Aa and the lower surface 20Ab.

The coil wiring line 40, the first connection conductor 51, and the second connection conductor 52 are made of a conductive material. In the present embodiment, the coil wiring line 40, the first connection conductor 51, and the second connection conductor 52 are made of a conductive material that is a metal material having a low electrical resistance, such as Cu, Ag, Au, or Al.

As illustrated in FIG. 2, the coil wiring line 40 is wound around an axial direction 101 to form a coil. In the present embodiment, the axial direction 101 is the up-down direction (Z direction) and crosses the upper surface 20Aa and the lower surface 20Ab. The upper surface 20Aa is an example of a crossing surface. The lower surface 20Ab is an example of an opposite surface.

The coil wiring line 40 includes a plurality of winding portions 41 extending in a circumferential direction 102 around the axial direction 101. Each of the plurality of winding portions 41 is wound around the axial direction 101 to form 1 turn. However, the innermost winding portion 41 of the plurality of winding portions 41 does not have to be wound around the axial direction 101 to form 1 turn. The coil wiring line 40 at least includes a first winding portion 411 and a second winding portion 412. The first winding portion 411 is wound around the axial direction 101 from one end portion 411A connected to the first connection conductor 51 to form 1 turn. The second winding portion 412 is continuous with the other end portion 411B of the first winding portion 411 and extends around the axial direction 101 inside the first winding portion 411.

In the present embodiment, the coil wiring line 40 includes two winding portions 41 (the first winding portion 411 and the second winding portion 412). In the present embodiment, the second winding portion 412 corresponds to the innermost winding portion 41 of the plurality of winding portions 41 and is wound around the axial direction 101 to form 0.5 turn. That is, in the present embodiment, the number of turns of the coil wiring line 40 is 1.5. The number of turns of the first winding portion 411 is 1. The number of turns of the second winding portion 412 is 0.5.

The coil wiring line 40 may include three or more winding portions 41. For example, when the coil wiring line 40 includes three winding portions 41, the coil wiring line 40 includes a third winding portion that is continuous with the other end portion of the second winding portion 412 (end portion opposite to the position where the second winding portion 412 is connected to the first winding portion 411) and that extends around the axial direction 101 inside the second winding portion 412. In this case, the third winding portion is the innermost winding portion 41 of the plurality of winding portions 41. Thus, the second winding portion 412 is wound around the axial direction 101 to form 1 turn. When the coil wiring line 40 includes four or more winding portions 41, an additional winding portion 41 is provided inside the coil wiring line 40 in a manner similar to the above manner.

The first winding portion 411 includes a first portion 4111 extending from the one end portion 411A of the first winding portion 411 in a direction having a component of a specific direction that is the direction in which a tangent passing through the one end portion 411A extends of the circumferential direction 102. In the present embodiment, the component of the specific direction is a component of the direction extending toward the one side (backward) in the Y direction. In FIG. 2, the first portion 4111 is a region surrounded by a long dashed short dashed line. That is, the first portion 4111 is a region from the one end portion 411A extending in one direction (backward) in the Y direction to a part connected to a part extending in a direction perpendicular to the Y direction (one direction in the X direction (rightward)) of the first winding portion 411.

The first winding portion 411 further includes a part extending from the first portion 4111 toward one side (rightward) in the X direction, a part extending from the part extending rightward toward the other side (forward) in the Y direction, and a part extending from the part extending forward toward the other side (leftward) in the X direction. A left end portion of the part extending leftward is the other end portion 411B of the first winding portion 411. That is, the first winding portion 411 is a region of the two winding portions 41 from the one end portion 411A extending in the specific direction to the other end portion 411B connected to one end portion 412A of the second winding portion 412 having the component of the specific direction described below. The part extending from the one end portion 411A to the other end portion 411B forms 1 turn of the first winding portion 411.

The second winding portion 412 includes a second portion 4121 extending from the other end portion 411B of the first winding portion 411 in a direction having the component of the specific direction (toward the one side in the Y direction). That is, the second portion 4121 has the same component of the direction as the first portion 4111. That is, when an electric current flows in the coil wiring line 40 and the electric current flowing in the first portion 4111 flows backward, an electric current flowing in the second portion 4121 also flows backward. In FIG. 2, the second portion 4121 is a region surrounded by a long dashed double-short dashed line. The second winding portion 412 includes the one end portion 412A, which is connected to the other end portion 411B of the first winding portion 411, and the other end portion 412B, which is an end portion opposite to the one end portion 412A.

The second winding portion 412 further includes a part extending from the second portion 4121 toward the one side (rightward) in the X direction. A right end portion of the part extending rightward is the other end portion 412B of the second winding portion 412. When the coil wiring line 40 includes three winding portions 41, the second winding portion 412 includes the second portion 4121 and the part extending from the second portion 4121 toward the one side (rightward) in the X direction and further includes a part extending from the part extending rightward toward the other side (forward) in the Y direction, and a part extending from the part extending forward toward the other side (leftward) in the X direction. A left end portion of the part extending leftward is the other end portion of the second winding portion 412. That is, the second winding portion 412 is a region from the second portion extending in the direction having the component of the specific direction to the other end portion connected to one end portion of the third winding portion having the component of the specific direction. In this case, the part extending from the second portion to the other end portion connected to the one end portion of the third winding portion forms 1 turn of the second winding portion.

As illustrated in FIGS. 2 and 3, when viewed in the axial direction 101, at least a part of the second portion 4121 in the width direction at any position in the second portion 4121 does not overlap the first external terminal 31, and the part other than the part of the second portion 4121 overlaps the first external terminal 31. In the inductor component 10, when viewed in the axial direction 101, it is sufficient that at least a part of the second portion 4121 in the width direction at any position in the second portion 4121 does not overlap the first external terminal 31. Here, the width direction is a direction orthogonal to the direction in which the coil wiring line 40 extends when viewed in the axial direction 101.

As illustrated in FIG. 3, the plurality of winding portions 41 are located on the same plane S1. That is, the first winding portion 411 and the second winding portion 412 are located on the same plane S1. The plurality of winding portions 41 do not have to be located on the same plane. For example, the first winding portion 411 and the second winding portion 412 may be located at different positions in the Z direction. In this case, the first winding portion 411 and the second winding portion 412 are connected to each other via, for example, a via conductor extending in the Z direction.

As illustrated in FIG. 2, the coil wiring line 40 includes pads 42 and 43. The pad 42 can be provided at any position in the first winding portion 411 of the plurality of winding portions 41. In Embodiment 1, the pad 42 is provided at the one end portion 411A of the first winding portion 411. The pad 43 can be provided at any position in one of the plurality of winding portions 41 different from the first winding portion 411. In the present embodiment, the pad 43 is provided at the other end portion 412B of the second winding portion 412. That is, in the present embodiment, the pad 42 is provided at one end portion of the coil wiring line 40, and the pad 43 is provided at the other end portion of the coil wiring line 40. In the present embodiment, the pads 42 and 43 are formed so as to be wider than the other part of the coil wiring line 40 when viewed in the axial direction 101.

As illustrated in FIGS. 1 and 2, the coil wiring line 40 includes branch wiring lines 44 and 45. The branch wiring line 44 is exposed at the front side surface 20Ac of the main body 20. The branch wiring line 45 is exposed at the rear side surface 20Ad of the main body 20. The branch wiring lines 44 and 45 are used for, for example, power supply from the outside of the inductor component 10.

As illustrated in FIG. 3, the first connection conductor 51 and the second connection conductor 52 extend in the Z direction. A lower end portion of the first connection conductor 51 is connected to the pad 42. An upper end portion of the first connection conductor 51 is connected to the first external terminal 31. That is, the first connection conductor 51 is connected to the first external terminal 31 and the coil wiring line 40. A lower end portion of the second connection conductor 52 is connected to the pad 43. An upper end portion of the second connection conductor 52 is connected to the second external terminal 32. That is, the second connection conductor 52 is connected to the second external terminal 32 and the coil wiring line 40.

In the present embodiment, the first external terminal 31 has a larger area than the first connection conductor 51 when viewed in the axial direction 101 but may be encompassed by the first connection conductor 51 when viewed in the axial direction 101. In addition, the second external terminal 32 has a larger area than the second connection conductor 52 when viewed in the axial direction 101 but may be encompassed by the second connection conductor 52 when viewed in the axial direction 101.

As illustrated in FIG. 2, the maximum length of the first connection conductor 51 along the component of the specific direction is longer than the maximum length of the first connection conductor 51 along a component of an orthogonal direction. In the present embodiment, the component of the specific direction is the component of the direction extending toward the one side in the Y direction. That is, the maximum length of the first connection conductor 51 along the component of the specific direction is a maximum length L1 of the first connection conductor 51 in the Y direction. The component of the orthogonal direction is a component orthogonal to the component of the specific direction of the circumferential direction 102. In the present embodiment, the component of the orthogonal direction is a component of the X direction orthogonal to the Y direction of the circumferential direction 102. That is, the maximum length of the first connection conductor 51 along the component of the orthogonal direction is a maximum length L2 of the first connection conductor 51 in the X direction. The maximum length L1 is longer than the maximum length L2.

In the present embodiment, a maximum length L3 of the second connection conductor 52 along the component of the specific direction (component of the Y direction) is longer than a maximum length L4 of the second connection conductor 52 along the component of the orthogonal direction (component of the X direction).

In addition, the value obtained by dividing the maximum length L1 by the maximum length L2 is larger than the value obtained by dividing the maximum length L3 by the maximum length L4. That is, this relationship is (L1/L2)>(L3/L4). The maximum length L1 is an example of a first maximum length. The maximum length L2 is an example of a second maximum length. The maximum length L3 is an example of a third maximum length. The maximum length L4 is an example of a fourth maximum length.

In the present embodiment, the first connection conductor 51 and the second connection conductor 52 have rectangular shapes having four round vertexes when viewed in the axial direction 101. The shapes of the first connection conductor 51 and the second connection conductor 52 when viewed in the axial direction 101 are not limited to such rectangular shapes having four round vertexes. For example, the vertexes of the first connection conductor 51 and the second connection conductor 52 do not have to be round. In addition, for example, the shapes of the first connection conductor 51 and the second connection conductor 52 may be shapes other than rectangular shapes, such as circular shapes or elliptical shapes when viewed in the axial direction 101. In addition, for example, the first connection conductor 51 and the second connection conductor 52 may have the same shape or size or different shapes or sizes when viewed in the axial direction 101.

The second connection conductor 52 may extend in a direction different from the direction in which the first connection conductor 51 extends. For example, when the second external terminal 32 is provided on the right side surface 20Af, the second connection conductor 52 may extend in the X direction toward the right side surface 20Af.

As illustrated in FIG. 3, the seed layer 60 is located below the coil wiring line 40. In other words, the coil wiring line 40 is laminated on the seed layer 60. The seed layer 60 is made of conductive materials. In the present embodiment, the seed layer contains titanium (Ti) and copper (Cu). The seed layer may contain titanium (Ti) and nickel (Ni). The seed layer 60 can be understood as a part of the coil wiring line. In this case, the coil wiring line has a two-layer structure including the seed layer 60 and an electrolytic plating layer (the coil wiring line 40).

The internal insulating layer 70 is located below the seed layer 60. In other words, the seed layer 60 is laminated on the internal insulating layer 70. The internal insulating layer 70 is made of an insulating material not containing a magnetic substance. The internal insulating layer 70 is made of, for example, an organic resin such as an epoxy resin, a phenolic resin, a polyimide resin, a liquid crystal polymer, or a combination of these substances, a sintered body such as glass or alumina, or a thin film such as a silicon oxide film, a silicon nitride film, or a silicon oxynitride film.

The internal insulating layer 70 is provided to cover one side of the coil wiring line 40 in the Z direction (lower side of the coil wiring line 40) with an insulator. On the other hand, the other side of the coil wiring line 40 in the Z direction (upper side of the coil wiring line 40) is not covered with an insulator. That is, a part of the coil wiring line 40 facing the first external terminal 31 and the second external terminal 32 is not covered with an insulator. In addition, the sides of the coil wiring line 40 are not covered with an insulator. That is, parts of the coil wiring line 40 facing the front side surface 20Ac, the rear side surface 20Ad, the left side surface 20Ae, and the right side surface 20Af are also not covered with an insulator.

The distances between parts of the coil wiring line 40 and the distances between the coil wiring line 40 and the outer surfaces 20A (the upper surface 20Aa and the lower surface 20Ab) of the main body 20 will be described below.

As illustrated in FIG. 2, when viewed in the axial direction 101, a distance D1, which is the shortest distance from the first portion 4111 to the second portion 4121, is longer than the shortest distance from the pad 43 to the winding portion 41 other than the second winding portion 412 provided with the pad 43 of the plurality of winding portions 41. Here, in the present embodiment, the winding portion 41 other than the second winding portion 412 provided with the pad 43 of the plurality of winding portions 41 is the first winding portion 411. Examples of the distance between the pad 43 and the first winding portion 411 include distances D2, D3, and D4, and the distance D2 is shortest. That is, when viewed in the axial direction 101, the distance D1 is longer than the distance D2, which is the shortest distance between the pad 43 and the first winding portion 411.

When viewed in the axial direction 101, the distance D1 is longer than the longest distance between respective parts of two adjacent winding portions 41 of the plurality of winding portions 41, the respective parts of the two adjacent winding portions 41 being located at the same position in the circumferential direction 102. In the present embodiment, the two adjacent winding portions 41 of the plurality of winding portions 41 are the first winding portion 411 and the second winding portion 412. Examples of the distance between respective parts of two adjacent winding portions 41 located at the same position in the circumferential direction 102 include the distances D2, D3, D4, and D5 illustrated in FIG. 2. The distance D5 is the longest distance of these distances. That is, when viewed in the axial direction 101, the distance D1 is longer than the distance D5, which is the longest distance between respective parts of the first winding portion 411 and the second winding portion 412 adjacent to each other, the respective parts of the first winding portion 411 and the second winding portion 412 adjacent to each other being located at the same position in the circumferential direction 102. The distance D1 is an example of an inter-part distance.

A distance D6 illustrated in FIG. 2 is a distance between the two adjacent winding portions 41 (the first winding portion 411 and the second winding portion 412) and is a distance between parts of the two adjacent winding portions 41 located at different positions in the circumferential direction 102. The directions in which an electric current flows at respective positions in the first winding portion 411 and the second winding portion 412 facing each other at the distance D6 are opposite directions. On the other hand, an electric current flows in the same direction at respective corresponding positions in the first winding portion 411 and the second winding portion 412 facing each other at each of the distances D2, D3, D4, and D5. In other words, parts located at the same position in the circumferential direction are parts where an electric current flows in the same direction.

As illustrated in FIG. 3, a distance D7, which is the shortest distance between the coil wiring line 40 and the first external terminal 31, is 2 times or more the shortest distance between the two adjacent winding portions 41 of the plurality of winding portions 41. In the present embodiment, the shortest distance between the two adjacent winding portions 41 (the first winding portion 411 and the second winding portion 412) is the distance D2 (see FIGS. 2 and 3). That is, the distance D7 is 2 times or more the distance D2.

The distance D7 between the coil wiring line 40 and the upper surface 20Aa in the axial direction 101 is shorter than a distance D8 between the coil wiring line 40 and the lower surface 20Ab in the axial direction 101. That is, the coil wiring line 40 is located closer to the upper surface 20Aa than the lower surface 20Ab in the axial direction 101.

Dimensions of constituent elements of the inductor component 10 described above are as follows, for example.

The thickness (length in the Z direction) of the main body 20 is 10 μm. The thickness of the external insulating layer 21 is 7 μm. In each of the first external terminal 31 and the second external terminal 32, the thickness of a Cu layer is 5 μm, the thickness of a Ni layer is 5 μm, and the thickness of an Au layer is 0.01 μm. The thickness of the coil wiring line 40 is 45 μm. A width W (see FIG. 2) of the coil wiring line 40 when viewed in the axial direction 101 is 70 μm. The thickness of each of the first connection conductor 51 and the second connection conductor 52 is 50 μm. The thickness of a layer made of titanium (Ti) of the seed layer 60 is 0.04 μm. The thickness of a layer made of copper (Cu) of the seed layer 60 is 0.10 μm. The thickness of the internal insulating layer 70 is 5 μm. The area of the main body 20 when viewed in the axial direction 101 is 1570 μm (the X direction)×770 μm (the Y direction). The area of each of the first external terminal 31 and the second external terminal 32 when viewed in the axial direction 101 is 440 μm (the X direction)×690 μm (the Y direction). The area of each of the first connection conductor 51 and the second connection conductor 52 when viewed in the axial direction 101 is 150 μm (the X direction)×250 μm (the Y direction). The dimensions of the constituent elements are not limited to the dimensions described above.

In the present embodiment, the shortest distance (in the present embodiment, the distance D2) between the two adjacent winding portions 41 (the first winding portion 411 and the second winding portion 412) of the plurality of winding portions 41 is 5 times or more the median grain size D50 of the magnetic material contained in the main body 20. In other words, the median grain size D50 of the magnetic material contained in the main body 20 is ⅕ or less of the shortest distance (in FIG. 2, the distance D2) between the two adjacent winding portions 41 of the plurality of winding portions 41. As described above, in the present embodiment, the median grain size D50 of the magnetic material contained in the main body 20 is 10 μm or less. That is, when the median grain size D50 of the magnetic material contained in the main body 20 is 10 μm, the shortest distance between the two adjacent winding portions 41 is 50 μm or more.

In the present embodiment, the distance between the coil wiring line 40 and the upper surface 20Aa in the axial direction 101 is 4 times or more the median grain size D50 of the magnetic material contained in the main body 20. The distance between the coil wiring line 40 and the upper surface 20Aa in the axial direction 101 is the distance D7. In addition, the median grain size D50 of the magnetic material contained in the main body 20 is 10 μm or less. That is, when the median grain size D50 of the magnetic material contained in the main body 20 is 10 μm, the distance D7 is 40 μm or more.

### Method for Manufacturing Inductor Component

An example of a method for manufacturing the inductor component 10 according to Embodiment 1 will be described below with reference to FIGS. 4 to 14 and FIG. 3. FIGS. 4 to 14 are schematic sectional views illustrating a method for manufacturing the inductor component according to Embodiment 1 of the present disclosure.

First, as illustrated in FIG. 4, an insulating film 82 is formed on the entire surface of a support substrate 81. The support substrate 81 is made of ceramic such as ferrite or alumina. The insulating film 82 is made of a resin such as an epoxy resin or a polyimide resin.

Next, as illustrated in FIG. 5, the internal insulating layer 70 is formed on a part of the insulating film 82. The internal insulating layer 70 has the same shape as the coil wiring line 40 when viewed in the axial direction 101.

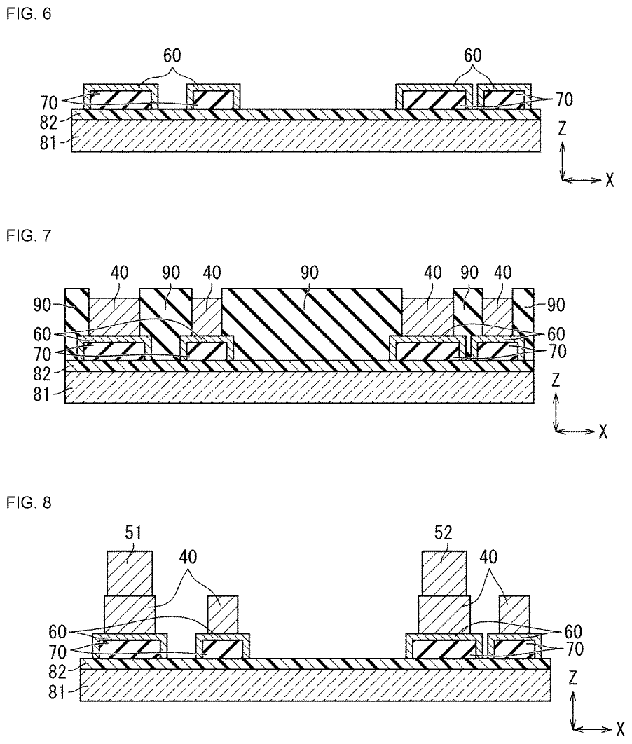

Next, as illustrated in FIG. 6, the seed layer 60 is formed on the internal insulating layer 70.

Next, as illustrated in FIG. 7, the coil wiring line 40 is formed on the seed layer 60. This will be described below in detail. First, a dry film resist (DFR) 90 is laminated on the insulating film 82 and the seed layer 60. Next, the DFR 90 is exposed. Thus, a pattern having the same shape as the part other than the coil wiring line is transferred to a part of the DFR 90 immediately above the seed layer 60. Next, the DFR 90 is developed. Thus, a part of the DFR 90 to which the pattern is not transferred is removed, and the seed layer 60 is exposed at the place where the part of the DFR 90 is removed. Next, electrolytic plating is performed. Thus, a metal film is formed. This metal film is the coil wiring line 40.

Next, as illustrated in FIG. 8, the first connection conductor 51 and the second connection conductor 52 are formed on the coil wiring line 40. The first connection conductor 51 and the second connection conductor 52 are formed as follows in a manner similar to the manner in which the coil wiring line 40 is formed. First, a DFR is laminated on the coil wiring line 40 and the DFR 90 in FIG. 7. Next, the DFR is exposed and developed, thus forming cavities having the same shapes as the first connection conductor 51 and the second connection conductor 52. Thereafter, electrolytic plating is performed. Thereafter, the DFR is removed. The first connection conductor 51 is formed on the pad 42 located at the one end portion of the coil wiring line 40. The second connection conductor 52 is formed on the pad 43 located at the other end portion of the coil wiring line 40.

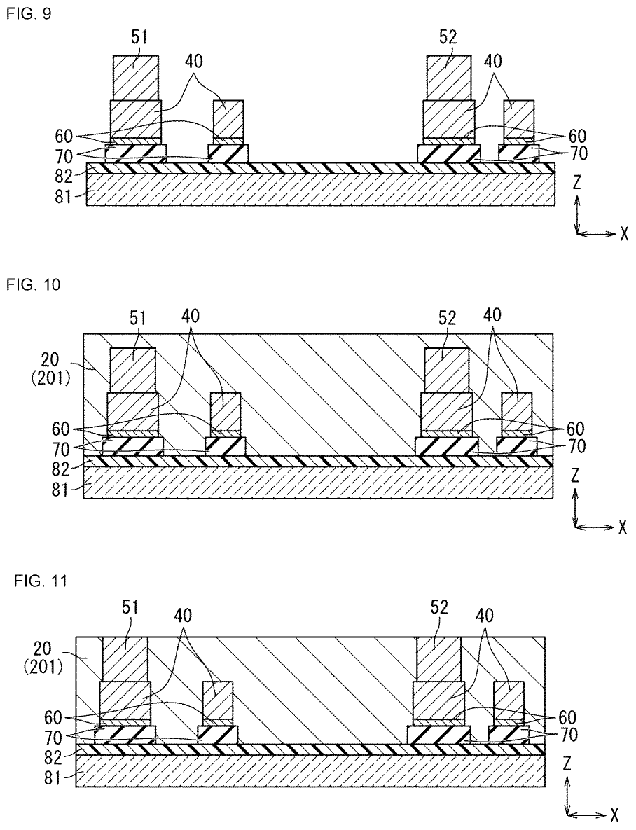

Next, seed etching is performed. Thus, a part of the seed layer 60 exposed to the outside in FIG. 8 is removed. As a result, as illustrated in FIG. 9, only a part of the seed layer 60 covered with the coil wiring line 40 is left.

Next, as illustrated in FIG. 10, a first magnetic layer 201 is formed on the insulating film 82 by a known method such as thermocompression bonding of a magnetic composite film made of a metal filler and a resin. Thus, the internal insulating layer 70, the seed layer 60, the coil wiring line 40, the first connection conductor 51, and the second connection conductor 52 are covered with the first magnetic layer 201.

Next, as illustrated in FIG. 11, the first magnetic layer 201 is ground by a known method such as mechanical polishing. Thus, the first connection conductor 51 and the second connection conductor 52 are exposed.

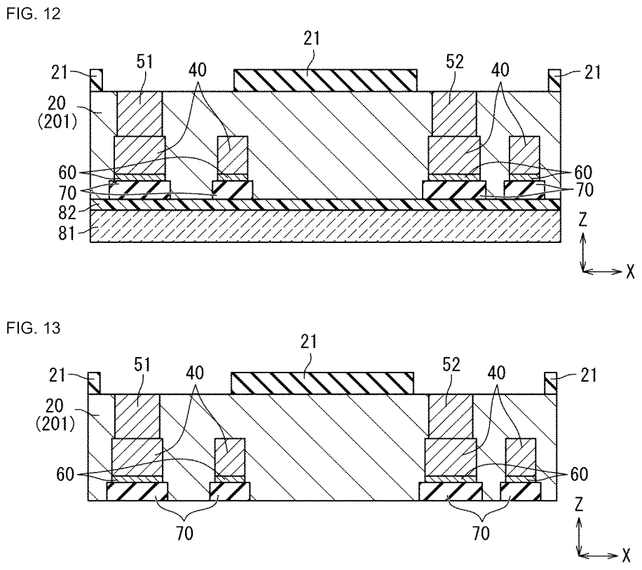

Next, as illustrated in FIG. 12, a solder resist (the external insulating layer 21) is formed on the first magnetic layer 201. The external insulating layer 21 is formed by a known method such as exposure and development. The external insulating layer 21 is formed on a part of the first magnetic layer 201.

Next, as illustrated in FIG. 13, the support substrate 81 and the insulating film 82 are removed by a known method such as mechanical polishing. Thus, the internal insulating layer 70 is exposed.

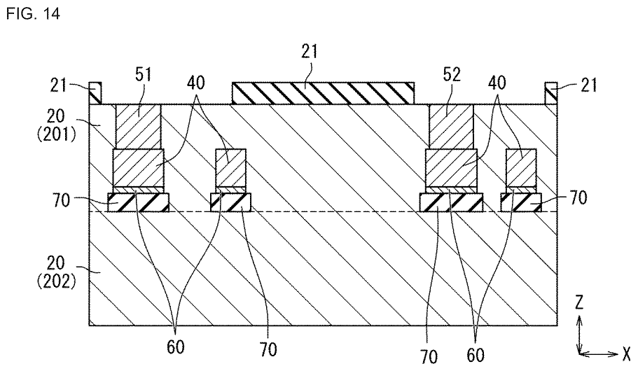

Next, as illustrated in FIG. 14, a second magnetic layer 202 is formed by a known method such as thermocompression bonding of a magnetic composite film made of a metal filler and a resin. The second magnetic layer 202 is formed so as to cover the exposed internal insulating layer 70. The first magnetic layer 201 and the second magnetic layer 202 form the main body 20. In FIG. 14, the boundary between the first magnetic layer 201 and the second magnetic layer 202 is represented by a dashed line. In FIG. 14, the thickness (length in the Z direction) of the second magnetic layer 202 is thicker than the thickness of the first magnetic layer 201. However, the thickness of the second magnetic layer 202 may be equal to or less than the thickness of the first magnetic layer 201.

Next, as illustrated in FIG. 3, the first external terminal 31 and the second external terminal 32 are formed by a known method such as plating. As a result, the inductor component 10 is completed. The first external terminal 31 and the second external terminal 32 are formed on respective parts of the first magnetic layer 201 where the external insulating layer 21 is not provided. The first external terminal 31 is connected to the exposed first connection conductor 51. The second external terminal 32 is connected to the exposed second connection conductor 52.

According to Embodiment 1, when viewed in the axial direction 101, at least a part of the second portion 4121 does not overlap the first external terminal 31. Thus, in Embodiment 1, compared with a configuration in which the entire second portion 4121 overlaps the first external terminal 31 when viewed in the axial direction 101, the part where the second portion 4121 and the first external terminal 31 overlap each other when viewed in the axial direction 101 is small. Thus, it is possible to reduce electric current leakage between the second portion 4121 and the first external terminal 31.

According to Embodiment 1, the first winding portion 411 and the second winding portion 412 are located on the same plane S1. Thus, compared with a configuration in which the first winding portion 411 and the second winding portion 412 are located on different planes, it is possible to reduce the thickness of the inductor component 10.

According to Embodiment 1, when viewed in the axial direction 101, a part of the second portion 4121 overlaps the first external terminal 31. Thus, compared with a configuration in which the second portion 4121 does not overlap the first external terminal 31 at all when viewed in the axial direction 101, it is possible to inhibit an increase in the size of the inductor component 10.

The potential difference between the first portion 4111 and the second portion 4121 is larger than that between other parts of the coil wiring line 40. According to Embodiment 1, the distance D1 between the first portion 4111 and the second portion 4121 between which the potential difference is large is longer than the distances D2 and D5. The long distance D1 enables a reduction in the electric field between the first portion 4111 and the second portion 4121. As a result, it is possible to improve the electric strength of the inductor component 10.

According to Embodiment 1, the part of the coil wiring line 40 facing the first external terminal 31 is not covered with an insulator. In this case, an electric current is likely to leak between the coil wiring line 40 and the first external terminal 31. However, according to Embodiment 1, as described above, when viewed in the axial direction 101, at least a part of the second portion 4121 does not overlap the first external terminal 31. Thus, even the configuration in which the part of the coil wiring line 40 facing the first external terminal 31 is not covered with an insulator can inhibit an increase in electric current leakage between the second portion 4121 and the first external terminal 31. In addition, since the part is not covered with an insulator, it is possible to increase the volume of the first magnetic layer 201 and to thus increase the inductance of the inductor component 10.

When the maximum length L1 of the first connection conductor 51 along the component of the specific direction (component of the Y direction) is shorter than the maximum length L2 of the first connection conductor 51 along the component of the orthogonal direction (component of the X direction), the distance between the first connection conductor 51 and the second portion 4121 when viewed in the axial direction 101 may be short. Thus, the distance from the first portion 4111 connected to the first connection conductor 51 to the second portion 4121 may be short. According to Embodiment 1, the maximum length L1 of the first connection conductor 51 along the component of the specific direction is longer than the maximum length L2 of the first connection conductor 51 along the component of the orthogonal direction. In this case, it is easy to increase the distance between the first connection conductor 51 and the second portion 4121 when viewed in the axial direction 101. Thus, it is easy to increase the distance from the first portion 4111 connected to the first connection conductor 51 to the second portion 4121. The distance between the first portion 4111 and the second portion 4121 is increased to easily lengthen the magnetic path of the coil wiring line 40 of the inductor component 10. As a result, it is possible to increase the inductance of the inductor component 10.

According to Embodiment 1, compared with the configuration in which the value obtained by dividing the maximum length L1 by the maximum length L2 is smaller than the value obtained by dividing the maximum length L3 by the maximum length L4, it is easy to increase the distance between the first portion 4111 and the second portion 4121. The distance between the first portion 4111 and the second portion 4121 is increased to easily lengthen the magnetic path of the coil wiring line 40 of the inductor component 10. As a result, it is possible to increase the inductance of the inductor component 10.

According to Embodiment 1, the first connection conductor 51 has a rectangular shape when viewed in the axial direction 101. In this case, compared with a case in which the first connection conductor 51 has a circular shape when viewed in the axial direction 101, it is easy to increase the area of the first connection conductor 51 when viewed in the axial direction 101. This large area enables a reduction in electrical resistance to a direct current flowing in the first connection conductor 51.

According to Embodiment 1, the number of turns of the coil wiring line 40 is 1.5. In this manner, the coil wiring line 40 whose number of turns is minimum forms a coil, thus enabling a reduction in the size of the inductor component 10.

According to Embodiment 1, compared with a configuration in which the distance D7, which is the shortest distance between the coil wiring line 40 and the first external terminal 31, is less than 2 times the distance D2, which is the shortest distance between the two adjacent winding portions 41, the shortest distance between the coil wiring line 40 and the first external terminal 31 is long. Thus, it is possible to reduce electric current leakage between the coil wiring line 40 and the first external terminal 31.

According to Embodiment 1, the distance D7 is shorter than the distance D8. Thus, it is possible to locate the coil wiring line 40, in which an electric current flows to generate heat, close to the conductive first external terminal 31. As a result, it is possible to improve heat dissipation from the inductor component 10.

According to Embodiment 1, compared with a configuration in which the median grain size D50 of the magnetic material contained in the main body 20 is more than 10 μm, it is possible to increase the filling density of the magnetic material.

According to Embodiment 1, compared with a configuration in which the median grain size D50 of the magnetic material contained in the main body 20 is more than ⅕ of the distance D2, which is the shortest distance between the two adjacent winding portions 41, it is possible to increase the filling density of the magnetic material.

A metal material is generally used for the magnetic material contained in the main body 20. Thus, the main body 20 may be oxidized. According to Embodiment 1, the external insulating layer 21 is laminated on the upper surface 20Aa of the main body 20, thus enabling a reduction in the amount of oxidation of the main body 20.

According to Embodiment 1, compared with a configuration in which the distance D7 between the coil wiring line 40 and the upper surface 20Aa in the axial direction 101 is less than 4 times the median grain size D50 of the magnetic material, it is possible to reduce electric current leakage via the magnetic material.

### Embodiment 2

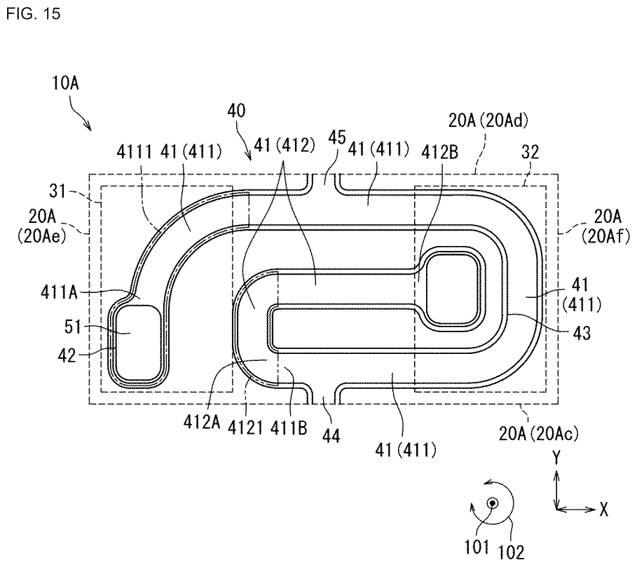

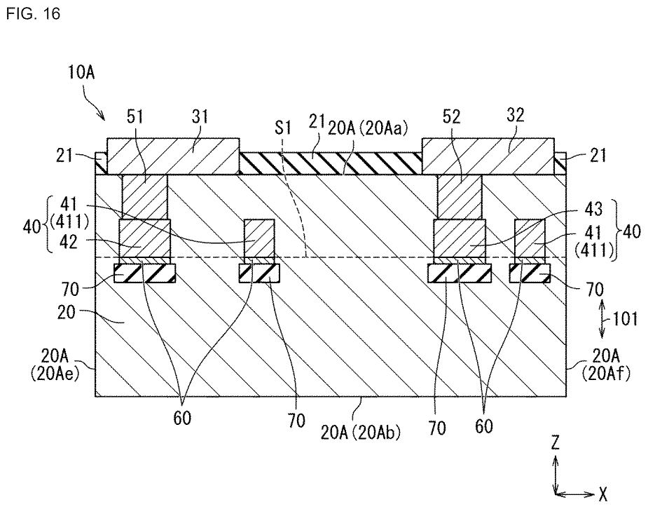

FIG. 15 is a schematic plan view of a coil wiring line of an inductor component according to Embodiment 2 of the present disclosure. FIG. 16 is a schematic sectional view illustrating a section corresponding to section III-III in FIG. 1 of the inductor component according to Embodiment 2 of the present disclosure. Features different from Embodiment 1 will be described below. In principle, the description of features similar to the inductor component 10 according to Embodiment 1 will be omitted.

As illustrated in FIGS. 15 and 16, in an inductor component 10A according to Embodiment 2, when viewed in the axial direction 101, the second portion 4121 does not overlap the first external terminal 31 at all. In this feature, the inductor component 10A differs from the inductor component 10 according to Embodiment 1, in which, when viewed in the axial direction 101, a part of the second portion 4121 does not overlap the first external terminal 31 and the part other than the part of the second portion 4121 overlaps the first external terminal 31.

That is, in the inductor component 10A, when viewed in the axial direction 101, at least a part of the second portion 4121 does not overlap the first external terminal 31.

According to Embodiment 2, when viewed in the axial direction 101, the second portion 4121 does not overlap the first external terminal 31 at all. Thus, compared with the configuration in which at least a part of the second portion 4121 overlaps the first external terminal 31 when viewed in the axial direction 101, it is possible to reduce electric current leakage between the second portion 4121 and the first external terminal 31.

The inductor components described above can also be expressed as follows.
(1) An inductor component according to an aspect of the present disclosure, comprising a main body containing a magnetic material; a coil wiring line that is provided in the main body and that is wound around an axial direction to form a coil; a first external terminal provided on a crossing surface crossing the axial direction of outer surfaces of the main body; a second external terminal provided on an outer surface of the main body; a first connection conductor that is provided in the main body, that extends in the axial direction, and that is connected to the first external terminal and the coil wiring line; and a second connection conductor that is provided in the main body and that is connected to the second external terminal and the coil wiring line. The coil wiring line includes a plurality of winding portions extending in a circumferential direction around the axial direction. The plurality of winding portions at least include a first winding portion wound around the axial direction from one end portion of the first winding portion connected to the first connection conductor to form 1 turn, and a second winding portion that is continuous with another end portion of the first winding portion and that extends around the axial direction inside the first winding portion. The first winding portion includes a first portion extending from the one end portion of the first winding portion in a direction having a component of a specific direction that is a direction in which a tangent passing through the one end portion of the first winding portion extends of the circumferential direction. The second winding portion includes a second portion extending from the other end portion of the first winding portion in a direction having the component of the specific direction. When viewed in the axial direction, at least a part of the second portion in a width direction at any position in the second portion does not overlap the first external terminal.
(2) The inductor component according to (1), wherein the first winding portion and the second winding portion may be located on the same plane.
(3) The inductor component according to (1) or (2), wherein when viewed in the axial direction, it may be that a part of the second portion does not overlap the first external terminal and that a part other than the part of the second portion overlaps the first external terminal.
(4) The inductor component according to (1) or (2), wherein when viewed in the axial direction, it may be that the second portion does not overlap the first external terminal at all.
(5) The inductor component according to any one of (1) to (4), wherein the coil wiring line may include a pad that is provided to one of the plurality of winding portions different from the first winding portion and that is connected to the second connection conductor. Also, when viewed in the axial direction, a shortest distance from the first portion to the second portion may be longer than a shortest distance from the pad to one of the plurality of winding portions other than the winding portion provided with the pad.
(6) The inductor component according to any one of (1) to (5), wherein when viewed in the axial direction, an inter-part distance that is a shortest distance from the first portion to the second portion may be longer than a longest distance, other than the inter-part distance, between respective parts of two adjacent winding portions of the plurality of winding portions, the respective parts of the two adjacent winding portions being located at the same position in the circumferential direction.
(7) The inductor component according to any one of (1) to (6), wherein it may be that a part of the coil wiring line facing the first external terminal is not covered with an insulator.
(8) The inductor component according to any one of (1) to (7), wherein a maximum length of the first connection conductor along the component of the specific direction may be longer than a maximum length of the first connection conductor along a component of an orthogonal direction orthogonal to the component of the specific direction of the circumferential direction.
(9) The inductor component according to any one of (1) to (8), wherein when a first maximum length is a maximum length of the first connection conductor along the component of the specific direction, a second maximum length is a maximum length of the first connection conductor along a component of an orthogonal direction orthogonal to the component of the specific direction of the circumferential direction, a third maximum length is a maximum length of the second connection conductor along the component of the specific direction, and a fourth maximum length is a maximum length of the second connection conductor along the component of the orthogonal direction, a value obtained by dividing the first maximum length by the second maximum length may be larger than a value obtained by dividing the third maximum length by the fourth maximum length.
(10) The inductor component according to any one of (1) to (9), wherein the first connection conductor may have a rectangular shape when viewed in the axial direction.
(11) The inductor component according to any one of (1) to (10), wherein the number of turns of the coil wiring line may be 1.5.
(12) The inductor component according to any one of (1) to (11), wherein a shortest distance between the coil wiring line and the first external terminal may be 2 times or more a shortest distance between two adjacent winding portions of the plurality of winding portions.
(13) The inductor component according to any one of (1) to (12), wherein the outer surfaces of the main body may include an opposite surface, the crossing surface and the opposite surface facing in opposite directions, the coil wiring line being interposed between the crossing surface and the opposite surface, and a distance between the coil wiring line and the crossing surface in the axial direction may be shorter than a distance between the coil wiring line and the opposite surface in the axial direction.
(14) The inductor component according to any one of (1) to (13), wherein a median grain size of the magnetic material contained in the main body may be 10 μm or less.
(15) The inductor component according to any one of (1) to (14), wherein a median grain size of the magnetic material contained in the main body may be ⅕ or less of a shortest distance between two adjacent winding portions of the plurality of winding portions.
(16) The inductor component according to any one of (1) to (15) may further comprise an insulating layer laminated on the crossing surface of the main body.
(17) The inductor component according to any one of (1) to (16), wherein a distance between the coil wiring line and the crossing surface in the axial direction may be 4 times or more a median grain size of the magnetic material contained in the main body.

Freely selected embodiments of the various embodiments can be combined as appropriate. Thus, it is possible to achieve effects of the embodiments.

The present disclosure is fully described through the preferred embodiments with reference to the drawings as appropriate. However, it is obvious to those skilled in the art that various alterations and modifications thereof can be made. It should be understood that such alterations and modifications are included in the present disclosure without departing from the scope of the present disclosure as defined by the appended claims.

What is claimed is:

1. An inductor component comprising:
a main body including a magnetic material;
a coil wiring line that is in the main body and that is wound around an axial direction to configure a coil;
a first external terminal on a crossing surface crossing the axial direction of outer surfaces of the main body;
a second external terminal on an outer surface of the main body;
a first connection conductor that is in the main body, that extends in the axial direction, and that is connected to the first external terminal and the coil wiring line; and
a second connection conductor that is in the main body and that is connected to the second external terminal and the coil wiring line, wherein
the coil wiring line includes a plurality of winding portions extending in a circumferential direction around the axial direction,
the plurality of winding portions at least include
a first winding portion wound around the axial direction from one end portion of the first winding portion connected to the first connection conductor to configure 1 turn, and
a second winding portion that is continuous with another end portion of the first winding portion and that extends around the axial direction inside the first winding portion,
the first winding portion includes a first portion extending from the one end portion of the first winding portion in a direction having a component of a specific direction that is a direction in which a tangent passing through the one end portion of the first winding portion extends of the circumferential direction,
the second winding portion includes a second portion extending from the other end portion of the first winding portion in a direction having the component of the specific direction, and
when viewed in the axial direction, at least a part of the second portion in a width direction at any position in the second portion does not overlap the first external terminal.

2. The inductor component according to claim 1, wherein
the first winding portion and the second winding portion are on the same plane.

3. The inductor component according to claim 1, wherein
when viewed in the axial direction, a part of the second portion does not overlap the first external terminal, and a part other than the part of the second portion overlaps the first external terminal.

4. The inductor component according to claim 1, wherein
when viewed in the axial direction, the second portion does not overlap the first external terminal at all.

5. The inductor component according to claim 1, wherein
the coil wiring line includes a pad that is at one of the plurality of winding portions different from the first winding portion and that is connected to the second connection conductor, and
when viewed in the axial direction, a shortest distance from the first portion to the second portion is longer than a shortest distance from the pad to one of the plurality of winding portions other than the winding portion provided with the pad.

6. The inductor component according to claim 1, wherein
when viewed in the axial direction, an inter-part distance that is a shortest distance from the first portion to the second portion is longer than a longest distance, other than the inter-part distance, between respective parts of two adjacent winding portions of the plurality of winding portions, the respective parts of the two adjacent winding portions being at the same position in the circumferential direction.

7. The inductor component according to claim 1, wherein
a part of the coil wiring line facing the first external terminal is not covered with an insulator.

8. The inductor component according to claim 1, wherein
a maximum length of the first connection conductor along the component of the specific direction is longer than a maximum length of the first connection conductor along a component of an orthogonal direction orthogonal to the component of the specific direction of the circumferential direction.

9. The inductor component according to claim 1, wherein
when a first maximum length is a maximum length of the first connection conductor along the component of the specific direction, a second maximum length is a maximum length of the first connection conductor along a component of an orthogonal direction orthogonal to the component of the specific direction of the circumferential direction, a third maximum length is a maximum length of the second connection conductor along the component of the specific direction, and a fourth maximum length is a maximum length of the second connection conductor along the component of the orthogonal direction, a value obtained by dividing the first maximum length by the second maximum length is larger than a value obtained by dividing the third maximum length by the fourth maximum length.

10. The inductor component according to claim 1, wherein
the first connection conductor has a rectangular shape when viewed in the axial direction.

11. The inductor component according to claim 1, wherein
a number of turns of the coil wiring line is 1.5.

12. The inductor component according to claim 1, wherein
a shortest distance between the coil wiring line and the first external terminal is 2 times or more a shortest distance between two adjacent winding portions of the plurality of winding portions.

13. The inductor component according to claim 1, wherein
the outer surfaces of the main body include an opposite surface, the crossing surface and the opposite surface facing in opposite directions, the coil wiring line being interposed between the crossing surface and the opposite surface, and
a distance between the coil wiring line and the crossing surface in the axial direction is shorter than a distance between the coil wiring line and the opposite surface in the axial direction.

14. The inductor component according to claim 1, wherein
a median grain size of the magnetic material in the main body is 10 μm or less.

15. The inductor component according to claim 1, wherein
a median grain size of the magnetic material in the main body is ⅕ or less of a shortest distance between two adjacent winding portions of the plurality of winding portions.

16. The inductor component according to claim 1, further comprising:
an insulating layer laminated on the crossing surface of the main body.

17. The inductor component according to claim 1, wherein
a distance between the coil wiring line and the crossing surface in the axial direction is 4 times or more a median grain size of the magnetic material in the main body.

18. The inductor component according to claim 2, wherein
when viewed in the axial direction, a part of the second portion does not overlap the first external terminal, and a part other than the part of the second portion overlaps the first external terminal.

19. The inductor component according to claim 2, wherein
when viewed in the axial direction, the second portion does not overlap the first external terminal at all.

20. The inductor component according to claim 2, wherein
the coil wiring line includes a pad that is at one of the plurality of winding portions different from the first winding portion and that is connected to the second connection conductor, and
when viewed in the axial direction, a shortest distance from the first portion to the second portion is longer than a shortest distance from the pad to one of the plurality of winding portions other than the winding portion provided with the pad.
